(19) United States
(12) Patent Application Publication
(10) Pub. No.: US 2011/0038064 A1
(43) Pub. Date: Feb. 17, 2011

(54) Flexible Arms of Low Footprint and High Weight-bearing

(76) Inventor: Ilo Kristo Xhunga, (US)

Correspondence Address: ILO KRISTO XHUNGA, 39211 Camelot Way, Avon, OH, 44011, US

(21) Appl. No.: 12/844,704

(22) Filed: Jul. 27, 2010

Related U.S. Application Data
(60) Provisional application No. 61/229,987, filed on Jul. 30, 2009.

(51) Int. Cl. F16M 13/00; F21V 19/02; G02B 7/02; E03C 1/00

(52) U.S. Cl. 359/811; 248/276.1; 248/288.11; 362/418; 4/695

(57) ABSTRACT

Flexible arms with structural features revealed by embodiments (22), (26), (30), (34), (38), (50), and (52). Flexible arms have cross sections perpendicular to the longitudinal axis that are elongated in the vertical direction, cross sections being longer in size vertically than horizontally. The above flexible arms are referred generically as novel arms (38). Structures of novel arms (38) derive from the detailed analysis of forces and torques exerted on loaded arms at work. To provide full adjustments of the arms in three dimensions, novel arms (38) are joined linearly with circular arms (46) into combined arms (54) as shown in several exemplifying applications. Other specific applications may employ arms (38) alone. Novel arms (38) and (54) have increased weight-bearing and reduced footprints compared to the prior art.

### PRIORITY

This application claims priority of U.S. 61/229,987, filed on Jul. 30, 2009.

### TECHNICAL FIELD

This invention relates to flexible arms, more specifically to the structural features of flexible arms.

### BACKGROUND ART

Flexible arms are often called bendable arms, goosenecks, curvilinear articulating arms, articulable columns, flexible stems, lockable articulating columns, or linkage assemblies. Flexible arms are made of a series of interconnected parts, often called pieces, segments, sections, joints, links, beads, arm members, hollow members, balls and sockets, balls and sleeves, or spirally-wound coil turns. The first of the two ends of a flexible arm is firmly or otherwise attached to a distal support, while the second end holds an object at a proximal position that can be adjusted by the user. Flexible arms have many applications. They support objects, articles, or instruments. Flexible arms are further used for positioning tools, providing passageways for electric wires, or transporting fluids. They are also used for locking medical measuring instruments in a fixed position as well as image recorders, radiating, or operating devices.

U.S. Pat. No. 3,858,578, disclosed by Milo et al, describes a surgical retaining device with a flexible arm comprised of a plurality of arm members having a central bore therethrough, an arcuate head portion and a conical tail portion that receives the head portion of another arm member; a cable extending through the bores gives the arm rigidity under tension.

U.S. Pat. No. 4,238,816, disclosed by Merlo, describes a lamp-holding flexible stem with resilient helical structure and decreasing diameter from the base to the lamp-holder.

U.S. Pat. No. 4,842,174, disclosed by Shepard et al, describes a device holding apparatus with a flexible support arm formed of a helical coil of wire of multiple turns with space in between.

U.S. Pat. No. 5,620,352, disclosed by Tzong, describes a flexible tube of joint members each having a neck portion of a reduced diameter formed between a spherical member and a semi-spherical member and a hollow passage for electric wires.

U.S. Pat. No. 6,164,570, disclosed by Smeltzer, describes a self-supporting shower hose with an outer structure comprising a plurality of ball and socket bead members each bendable with respect to adjacent bead members, and which is reconfigurable by the hands of the user to direct water spray as needed.

U.S. Pat. No. 6,626,210, disclosed by Luettgen et al, describes a flexible arm assembly of interconnected beads made of two different materials for improving the adjustment of the structure in three dimensions and increasing the weight of the object supportable by the arm assembly.

U.S. Pat. No. 6,648,376, disclosed by Christianson, describes a shower flexible arm of ball and socket sections that have a through hole containing a series of cylindrical sleeves that prevent the arm from being bent too far and sections separated.

U.S. Pat. No. 6,680,844, disclosed by Kim, describes a computer light supported by a gooseneck cable. The rigidity of the gooseneck is introduced by a pair of tubings made of metal wire wound into tight circular spirals.

U.S. Pat. No. 6,860,668, disclosed by Ibrahim et al, describes a method and apparatus for improving stiffness of a metallic linkage assembly by using coupled links of different metallic compounds of high friction between surfaces forced in tight contact by a tensioning cable.

U.S. Pat. No. 7,066,411, disclosed by Male and Hollinshead, describes a flexible shower arm assembly comprising a plurality of interconnected beads that form an axially extending bore, each bead rotatable with respect to adjacent beads. The flexible shower arm encloses along its bore an elongated flexible member defining a fluid transfer path. A sheath covers the flexible arm along its length.

U.S. Pat. No. 7,100,238, disclosed by McCauley, describes an extension arm for a tool made of a deformable stiffening wire and a sheath inclosing and preventing the wire from over-bending. The extension arm is bendable by the user, but stiff enough to retain its shape during tool usage.

EP 0 721 082, disclosed by Russo, describes a flexible core assembly connecting a flashlight and a battery, the assembly comprising a plurality of interconnected and universally rotatable members forming a flexible spine with a longitudinally extending bore and a resilient sleeve enclosing the spine.

U.S. Pat. No. 7,201,716, disclosed by Boone et al, describes a method and apparatus for temporarily immobilizing a local area of tissue during heart surgery, in which an articulating arm supports two or more suction pods. The articulating arm comprises a plurality of ball and socked plastic links. Each adjacent link comprises a hemispherical protrusion and a hemispherical indentation that allow links to rotate smoothly. A cord running through a longitudinal bore tightens the links and stiffens the arm when tensioned.

U.S. Pat. No. 7,337,808, disclosed by Shamir et al, describes a bimodal flexible-rigid hose comprised of a plurality of adjacently engaged hollow members defining an elongated hollow. A flexible tube for conveying fluids and a cable pass through the hollow. An actuator is adapted to apply low and high tensile forces on the cable converting the hose from a flexible state to a rigid one.

U.S. Pat. No. 7,395,563, disclosed by Whitmore et al, describes a medical supporting system for tomography imaging that involves one or more curvilinear articulating arms of the type of ball and socket or ball and sleeves disposed on a tensioning wire. The arm can hold a steady position in a locked mode for a wide range of medical instruments. Arms are configured to have one or more fittings that permit various instruments to be attached or grasped.

Publication US 2009/0060473, disclosed by Kohte, describes a portable media device holder comprising a soft aluminum rod with two clamps at its ends and covered by a sheath.

Publication US 2009/0072107, disclosed by Wilson et al, describes a medical device comprising an elongated articulating arm mounted at an MRI scanner. The arm includes a flexible elongated tensioning member and a series of non-magnetic, non-conductive pivoting segments, restricted from twisting about the longitudinal axis of the arm. To achieve a small footprint of the arm in the operative field the series of segments is tapered with larger segments at the base and progressively smaller segments proceeding to the free end.

Regardless of the variety and progress brought about by the afore-referenced (and other) patents, one characteristic of flexible arms has escaped attention and has not been scrutinized—all types of flexible arms of the prior art have circular cross sections. The arms are designed as if they were going to work in a circularly symmetric force field. However, the force field of the weight is not circular. Weight is unidirectional—it applies downward. The weight of the supported object or the transported fluid and the weight of the flexible arm itself are exerted vertically downward on the arm. Conventional arm designs that are circular in cross section do not match the weight forces that are unidirectional. Circular orientation of structural elements is ineffective at counteracting the unidirectional orientation of weight forces. This circular-unidirectional mismatch is the main reason behind the conventional arm drawbacks such as the bulkiness, heavy arm weight, low weight-bearing, and large footprint that unduly restrict the user's working space.

### DISCLOSURE OF INVENTION

### Objects

Introducing new structural features of the beads and arms in response to the unique directionality of weight forces. The new arm structures should match the directionality of the weight field, increase the weight-bearing, and reduce the footprint of flexible arms in the working area.

### SUMMARY

Terms flexible arm, arm, and gooseneck have the same meaning and are used interchangeably in this disclosure. Terms novel arm, novel gooseneck, or elongated cross section arm refer to flexible arms with vertically elongated cross sections. Terms circular flexible arm, circular arm, or circular gooseneck define arms with cross sections that are circles. The cross sections cut the arm perpendicularly to its length as defined in the detailed description and shown in the drawings.

The new method of the present invention has its foundation on the analysis of frictional forces and weights, and the balancing of counteracting torques on the arm. The method employs two main steps. In the first step, the novel goosenecks with vertically elongated cross sections are designed. In the second step, the novel gooseneck is combined with a circular gooseneck. The two goosenecks of different cross sections are joined linearly or one-after-the-other in one combined arm. The novel gooseneck contributes to the combined arm its increased weight-bearing, while the circularly symmetric gooseneck contributes its easy vertical bending. The vertically-elongated profile of the novel gooseneck increases the weight-bearing of the arm without unduly restricting the user's accessibility at the load site. In other words, the novel gooseneck is horizontally thinner and in spite of its reduced cross-section it has increased weight-bearing compared to the conventional round gooseneck of larger cross-sections, as shown in the calculations of counteracting torques in the detailed description that follows.

The drawings and the specification describe seven novel gooseneck embodiments first, and then one circular one. Further, the method's steps and working principles are described. In the last part, three apparatus applications are disclosed by example. All three apparatus employ flexible arms that are linear combinations of two different gooseneck parts—at the end of a longer novel gooseneck is attached a shorter length of a circular one. The combined arm provides three-dimensional manipulation of the load. In the first example of an apparatus application, a lighting device is supported at the proximal end of the combined arm that has its distal end rigidly connected to a floor stand. In the second application, an optical lens is manipulated at one end of the combined arm while the other end is rigidly attached to the surface of a wall or another object, equipment, or machinery. In a third apparatus, the combined arm transports water through the interior channel of the gooseneck from a shower pipe connected at its distal end, to the showerhead attached at gooseneck's proximal end.

### BRIEF DESCRIPTION OF DRAWINGS

FIG. 1A is a perspective view of a novel gooseneck embodiment. The entire bending of the gooseneck is on the horizontal plane H.

FIG. 1B is a perspective view of the gooseneck of FIG. 1A. The entire bending of the arm is on the vertical plane V.

FIG. 1C enlarges two contiguous beads in a vertical-plane cross section running along the central longitudinal line of the arm.

FIGS. 2A, 2B, and 2C are like FIGS. 1A, 1B, and 1C for another flexible-arm embodiment.

FIGS. 3A, 3B, and 3C are similar to FIGS. 1A, 1B, and 1C for yet another flexible-arm embodiment.

FIGS. 4A, 4B, and 4C are analogous to FIGS. 1A, 1B, and 1C for another flexible-arm embodiment.

FIG. 5A is the generic view of the flexible arm shown in detail in FIGS. 5B and 5C. FIG. 5A is also the generic view for the all novel arms of the present invention.

FIG. 6A is the generic view of the circular arm shown in detail in FIG. 6B. FIG. 6A shows the left side of the arm bent on the vertical plane and the right side bent on the horizontal plane. FIG. 6A represents generically the arms of the prior art or the circular arm embodiment of the present invention.

FIG. 7 is another embodiment of a flexible arm with its internal structure shown enlarged. The arm is made of two circular arms stacked up vertically and joined along their entire length of contact.

FIGS. 8A and 8B show yet another embodiment of the novel arms of the present invention. The bending of the arm is entirely on the horizontal plane H in FIG. 8A, while the bending of the same arm is entirely on the vertical plane V in FIG. 8B.

FIGS. 9A and 9B show the torque diagrams of novel arm embodiment shown in FIGS. 1A to 1C. FIGS. 9A and 9B are generic and principally describe also forces and torques of other embodiments of the present invention.

FIG. 10 is a perspective view of the combination of a novel arm and a circular arm, both shown in generic forms.

FIG. 11 shows a segmental reduction in size of an embodiment of novel arms.

FIG. 12 shows a lighting device held at one end of the linear combination of the novel gooseneck with the circular gooseneck while the other end of the combined gooseneck is rigidly connected to a floor stand.

FIG. 13 shows an optical lens held at one end of the linear combination of the novel gooseneck with the circular gooseneck while the other end of the combined gooseneck is rigidly connected to a support plate.

FIG. 14 shows a showerhead held at one end of the linear combination of the novel gooseneck with the circular gooseneck while the other end of the combined gooseneck is rigidly connected to a connection plate.

### THE BEST MODES FOR CARRYING OUT THE INVENTION

The following description and drawings disclose a novel method and apparatus of flexible arms with increased weight-bearing. The first six pages of drawings show various arm embodiments, page seven illustrates the method's steps and working principles, and the last three pages disclose applications employing the new arms.

It should be noted that drawing figures are given as examples and preferred embodiments only, and in no way limit the scope of the present invention as defined in the appended Description and Claims.

### Embodiments

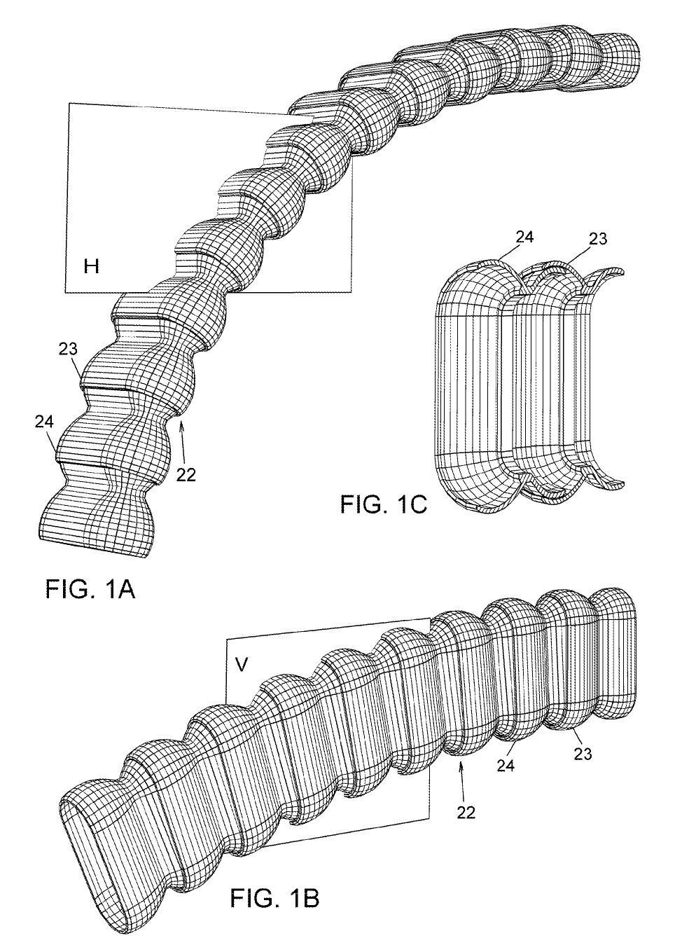

Flexible arms are bendable structures that can be reconfigured by applying force on the parts of the arm. Embodiment 22 is a novel flexible arm of joined beads. It is easily bendable and reconfigured by the hands of the user in three dimensions. While the entire bending of arm 22 shown in FIG. 1A lays on the horizontal plane H, the whole bending of arm 22 in FIG. 1B lays on the vertical plane V.

Novel arm embodiment 22 comprises a plurality of joined beads 23 and 24. Each bead has an arcuate tail portion of reduced size formed therein, whose outer surface enters and frictionally engages with the arcuate inner surface of the head portion of a contiguous or immediately adjacent bead. In other words, the outer surface of a bead is engaged with the inner surface or recess of a contiguous bead. Thus, head-to-tail mating beads of the flexible arm have swivel joints. Mating beads can swivel by sliding against one another when forced by the user's hand(s). The arm is simple and reliable in construction, and while flexible when required, it preserves the configuration in which it is bent due to frictional forces.

The reader can notice the different bending curvatures of the arms in FIGS. 1A and 1B. Arm 22 is more bendable on the horizontal plane H, shown in FIG. 1A, rather than on the vertical plane V, shown in FIG. 1B. This is an inherent characteristic of the novel arms of the present invention that is directly related to the beads' design. Looking at the drawings, the reader will notice that beads 23 and 24 are circularly asymmetric. They are extended more along the vertical direction than the horizontal one. The extended feature will be further illustrated on page 7 of the drawings and discussed in the following section on the method's steps and working principles.

There are two kinds of cross-sections in this disclosure: the first kind (pages 1 through 5 of the drawings) cut the flexible arm vertically along the central longitudinal line of the arm, and the second kind (FIG. 10 of page 7) cut the flexible arm perpendicularly to the longitudinal line of the arm. FIG. 1C is a cross sectional view of the first kind that reveals the interiors of contiguous beads 23 and 24. Each bead has a bore, lumen, lunette, hollow, or through-hole that communicates with the holes of adjacent beads, forming a continuous passage or channel that permits an object to be engaged therein such as a flexible plastic tube for liquid transfer, or electric wires for power supply.

The beads can vary in size along the length of the arm (not shown in FIGS. 1A to 1C) with the beads in the most distal portion of the arm (the right side of figures) being the largest, the beads in the most proximal portion (the left side) the smallest, and the middle portion somewhere in between. Decreasing the bead size allows a lower profile assembly that improves the ability to use the device without unduly restricting the user's accessibility to the working site. A variation of bead sizes in groups of beads or segments is shown on page 7, FIG. 11 of an additional novel arm embodiment (embodiment 30).

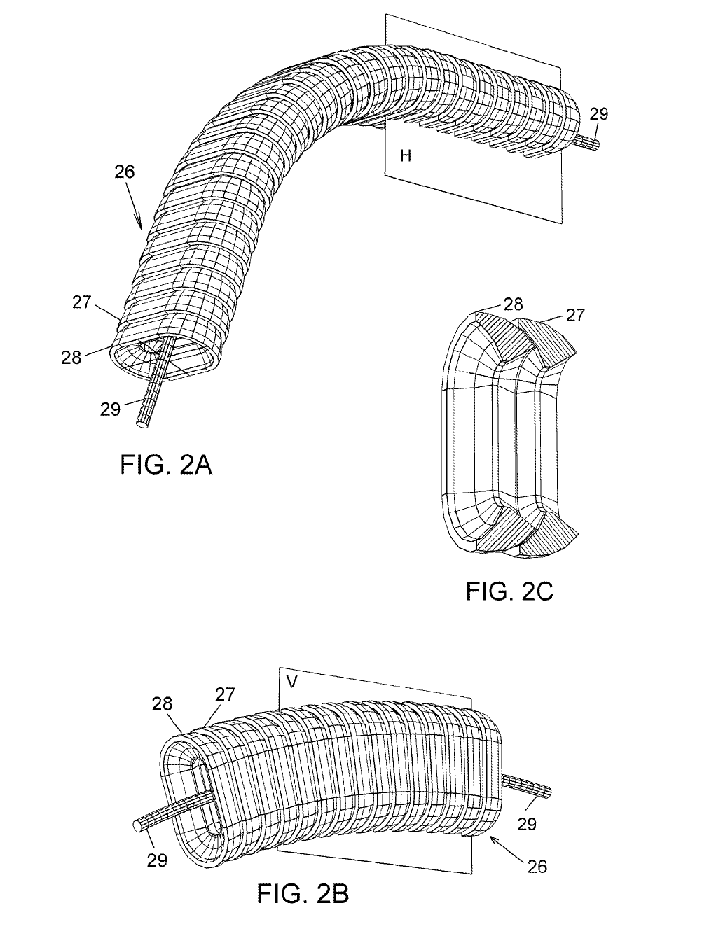

FIGS. 2A, 2B, and 2C show gooseneck embodiment 26. They are analogous to FIGS. 1A, 1B, and 1C. Gooseneck 26 is made of a plurality of beads 27 and 28 positioned head to tail and engaged pivotally. Their engagement is frictional along the contact surfaces. The protruding surface of bead 28 and the recessing surface of contiguous bead 27 create frictional forces along the areas of contact. Their frictional engagement is controlled by tensioning cable 29 running longitudinally inside gooseneck 26 through the hollow passage. The tension of cable 29 is controlled by an actuator and a handle (not shown) positioned either at the proximal or the distal end of gooseneck 26. When the handle is pressed, all beads are forced in tight contact by tensioning cable 29, frictional forces between beads are increased, and gooseneck 26 becomes rigid. When the tensioning cable is released, frictional forces are reduced and gooseneck 26 becomes bendable. Gooseneck tensioning cables and their actuators and handles are well known in the art and described in detail in the afore-referenced patents and publications, by reference incorporated in their entirety.

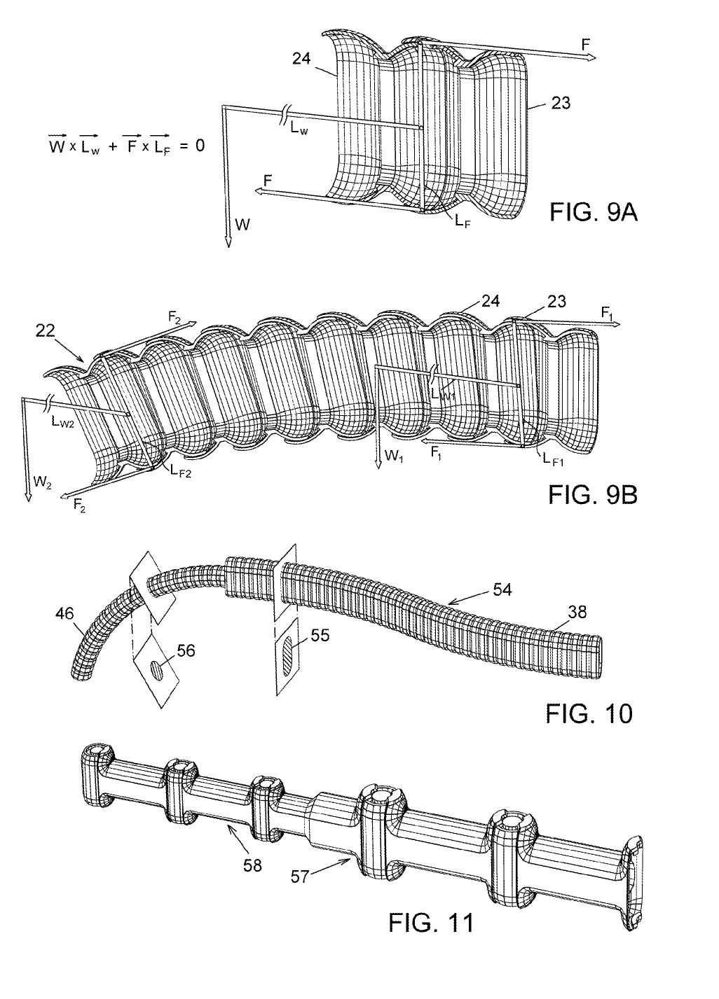

The horizontal bending shown in FIG. 2A is drawn with a turn four times sharper (smaller radius of curvature) than the vertical bending shown in FIG. 2B. Each bead is pivoted relative to an immediately adjacent bead by 6 degrees in FIG. 2A and only by 1.5 degrees in FIG. 2B. The purpose is to show that the novel arm of embodiment 22 has more bendability on the horizontal plane H than on the vertical plane V. It is the specific design of the beads that determines the limit of bending. As shown enlarged for a better view in FIG. 2C, beads 27 and 28 are circularly asymmetric; they are elongated more in the vertical direction than in the horizontal one. Elongation of the beads in the vertical direction appreciably influences the weight-bearing of the arm, as well as the permitted bending in that direction. More details on forces, torques, and weight-bearing are shown in FIGS. 9A, 9B, and 10, and discussed in the following section.

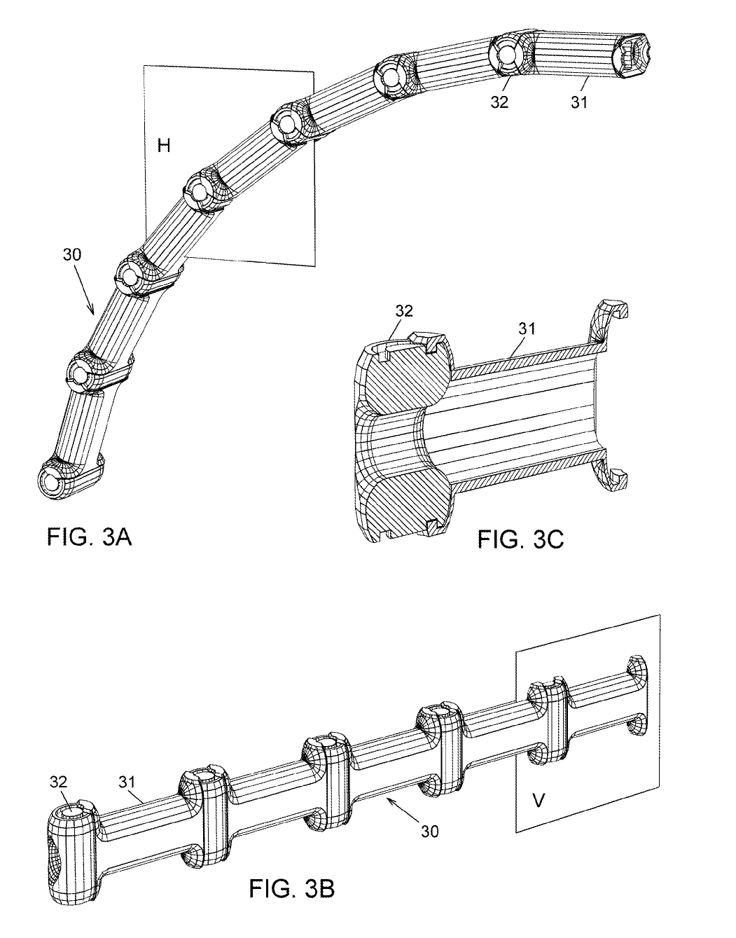

FIGS. 3A, 3B, and 3C, similar to the corresponding figures of the previous pages, show embodiment 30 of a curvilinear articulating arm, resembling the ball-and-sleeve type of arms, but principally new. FIG. 3A shows that arm 30 is easy bendable on the horizontal plane H. FIG. 3B shows that arm 30 has no bending on the vertical plane V. The lack of bending in the vertical direction is associated with arm 30 having an extremely high weight-bearing—up to the breaking point of the mechanical engagement between beads.

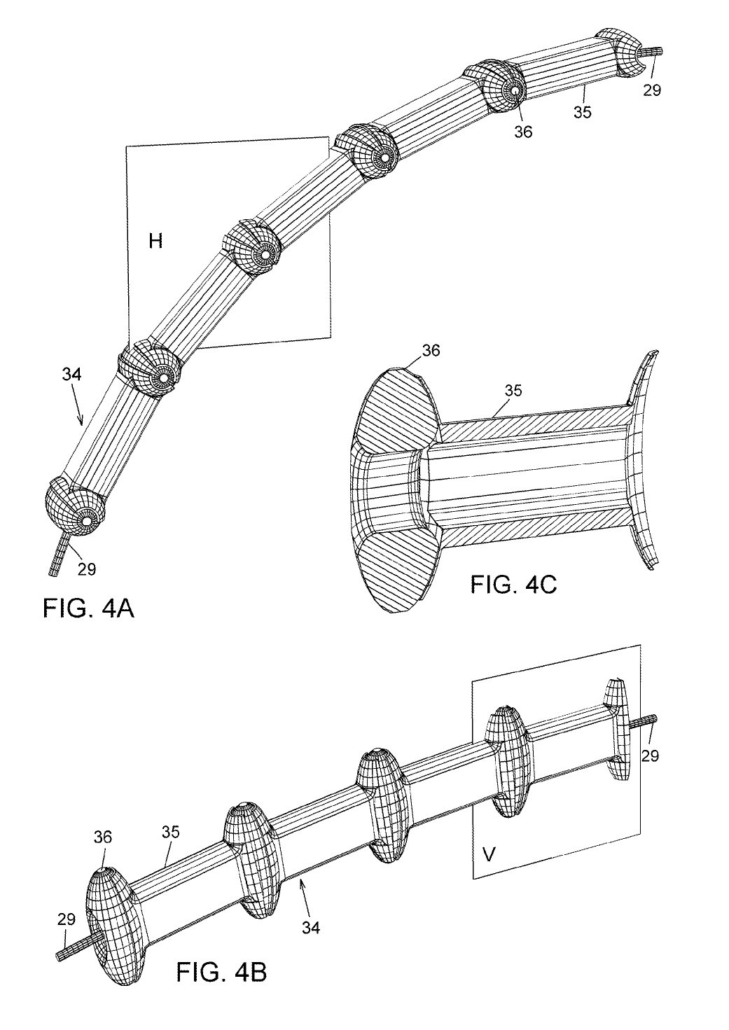

FIGS. 4A, 4B, and 4C are also analogous to the previous corresponding figures and show embodiment 34 of a curvilinear articulating arm of the ball and sleeve type, employing tensioning cable 29 to control pressing forces and friction between contact surfaces of beads 35 and 36. The pressing force of tensioning cable 29 is controlled by an actuator and a handle (not shown) positioned either at the distal or the proximal end of curvilinear articulating arm 34. The arm has enhanced weight-bearing due to its design features. Arm 34 is more bendable on the horizontal plane H (shown in FIG. 4A) and less on the vertical plane V (shown in FIG. 4B). Also notice the hollow passage along the bead interior and the surfaces of frictional contact between beads 35 and 36 in FIG. 4C.

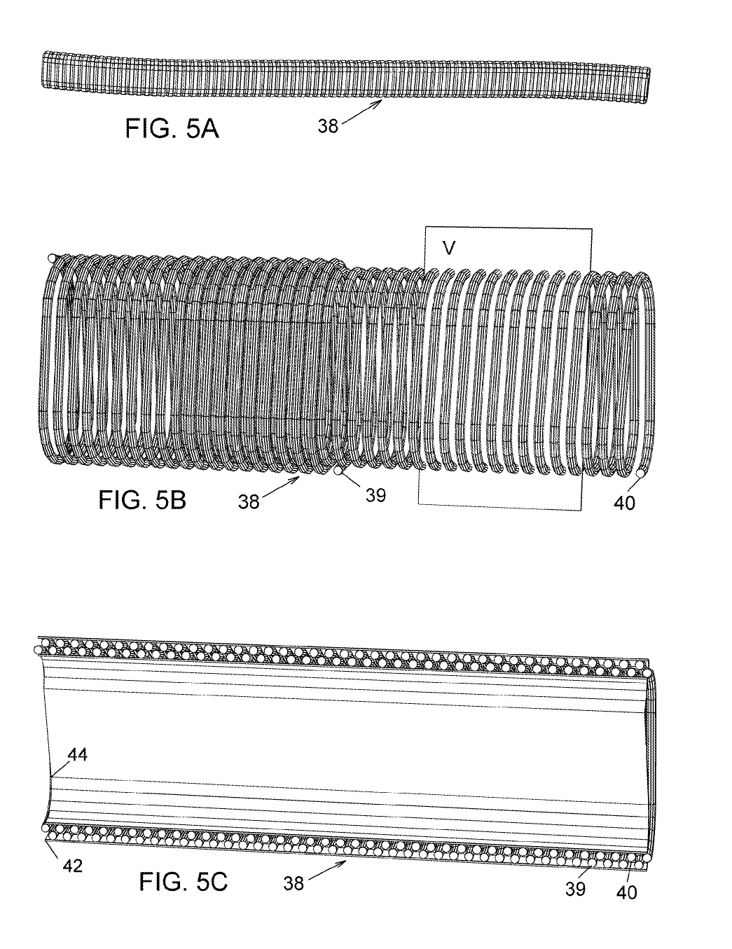

FIG. 5A shows a generic remote view of flexible arm 38. The generic view of arm 38 is also used to generically represent embodiments 22, 26, 30, 34, 50, and 52 in FIGS. 10, 12, 13, and 14 that reveal the method and apparatus of the present invention.

FIGS. 5B, and 5C show the structure of arm embodiment 38, which employs coils of wire enclosing each other. A segment of arm 38 is shown enlarged in FIG. 5B to reveal its wire-coil structure. Vertical plane V runs through the central axes of the coils. A segment of arm 38 is also shown enlarged in a cross section of the first-kind in FIG. 5C. FIGS. 5B and 5C show coils made of non-circular turns. The turns are extended more along the vertical direction than the horizontal one, the form of a turn resembling an ellipsis with a larger vertical axis. Being a plurality of repetitive turns, coils also have longer heights than widths. Outer coil 39 and inner coil 40 are coaxial, and the entire coil structure is covered with outer coating 42 and inner coating 44. The coatings are made of elastomeric material. Any elastomeric materials like silicon rubber or other similar materials can be used for coatings. Arm 38 encloses a channel or passage that can be used to carry conducting wires for electrical connections or to carry fluids in various applications.

The flexible arm's bendability and weight-bearing are determined by the ratio of the large and small elliptical axes of the turns, clearance gaps between turns, clearance gap between inner coil 40 and outer coil 39, the winding direction of the coils, coil size and material, wire thickness, etc. By varying the above factors, the properties of embodiment 38 can be controlled and altered in broad ranges. The gaps among turns between coatings 42 and 44 may be filled with silicone caulk or other filler (not shown) to further increase the weight-bearing of arm 38.

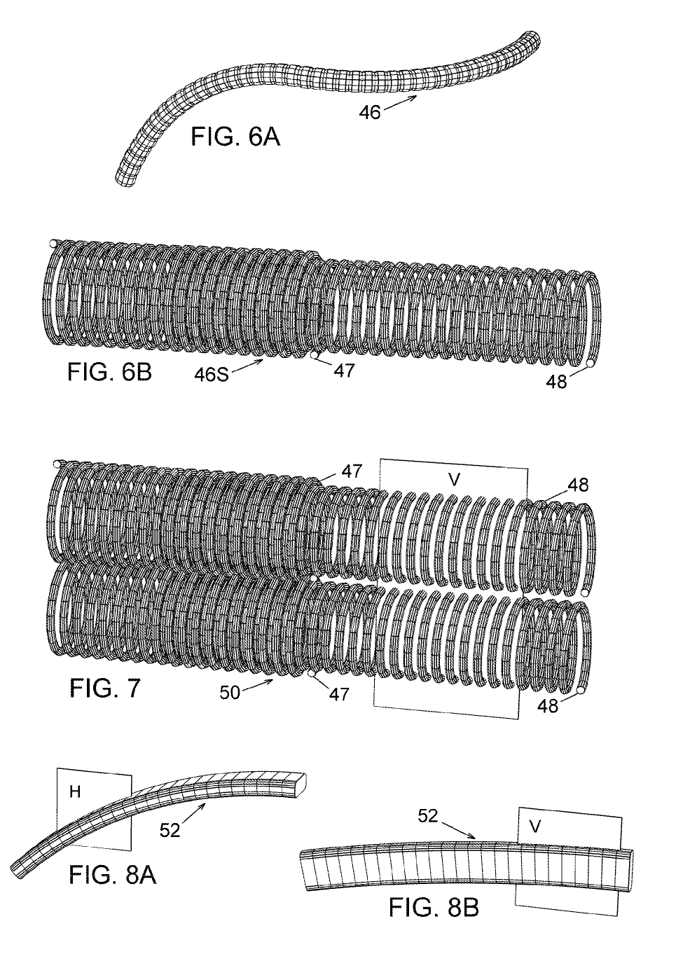

FIGS. 6A and 6B show flexible arm 46. The second-type cross sections of arm 46 are circles, as shown by circular cross section 56 in FIG. 10. FIG. 6B reveals the structure of circular arm 46 made of circular coils of wire where outer coil 47 encloses inner coil 48. The two circular coils are coaxial. Arm 46 is completed with inner and outer coatings and preferably with elastomeric filler (not shown). FIG. 6A shows arm 46 in a generic, remote view. (In FIGS. 10, 12, 13, and 14, generic view 46 represents, besides arm 46, circular arms of the prior art that can be used in combination with the novel arms of the present invention).

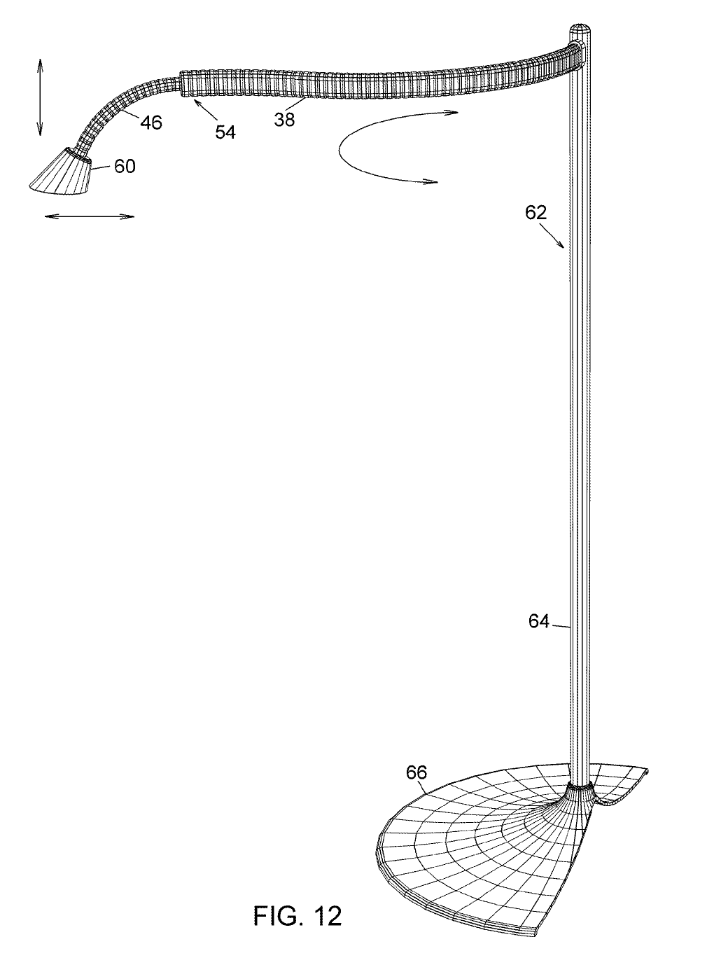

Novel gooseneck 38 and circular gooseneck 46 are joined in the linear combination of arm 54 (shown in the generic, remote view of FIG. 10). Combination arm 54 is fundamental to the present invention. The spans of space (relatively large in most applications) from the distal supported end of combination arm 54 (FIGS. 12, 13, and 14) to the proximal load-attaching end may require large weight-bearing from arm 54 (weight-bearing is defined per unit of arm length). It is novel gooseneck 38, with its enhanced weight-bearing, that enables combination arm 54 to span large distances from the supporting end to the connection point with circular gooseneck 46. For the shorter distances from the load to the point where the two goosenecks are joined, circular gooseneck 46 can provide the needed weight-bearing and flexibility in the vertical direction. This topic will be discussed in more detail in the following section on the method's steps and principles.

FIG. 7 shows embodiment 50 of the novel arms that can be manufactured using two circular-arm coil structures stacked on top of each other along the entire length. Central axes of coils are on vertical plane V. The two structures are linked into a single, vertically stacked structure by an elastomeric material (not shown), forming a longitudinal bonding strip that extends through the entire arm length. Besides the coating, the bond between the stacked-up circular coils can be preferably reinforced by one or more stitching wires (not shown) running along the longitudinal strip. Novel flexible arm 50 may have more than two stacked-up circular coil structures, to further increase its weight-bearing and rigidity in the vertical direction. The novel arm's weight-bearing is determined by the number of stacked-up circular coils, and by the properties of individual coils (determined by coil diameters, clearance gaps between coils, coil winding directions, coil material, wire thickness, etc). The properties of novel arm 50 can be varied in broad ranges by manipulating the number of stacked-up coils and the characteristics of each circular coil. The whole structure of embodiment 50 is covered with coatings (not shown) on the outer and inner sides of the coils.

FIGS. 8A and 8B show embodiment 52 of the novel arms. Arm 52 is a soft aluminum rod enclosed inside a coating sheath (not shown) made of an elastomeric material. The arm has a non-circular, vertically elongated profile. The profile is longer vertically than horizontally and increases the arm's weight-bearing. FIG. 8A shows arm 52 with its bending on horizontal plane H and FIG. 8B shows arm 52 with its bending on vertical plane V. Notice that the bending of the rod is more noticeable on the horizontal plane H than the vertical plane V, due to its vertically extended profile.

The vertically elongated cross-sectional profiles are the main common characteristic of the seven novel embodiments of the present invention. The cross sections are substantially elliptical, the large axis of the ellipsis being oriented vertically as the arm is mounted in apparatus applications. Such working orientation of the arms is of the essence, because it must match the downward orientation of the weight forces. It is important to be emphasized that, besides ellipsis, cross sections of the arms can have many other vertically elongated forms, such as elongated circles or other plane surfaces bounded substantially by any curved lines, so long as the cross sections are stretched (longer in height than width) in one direction. The increased weight-bearing of the novel goosenecks is substantially due to the above vertically elongated cross sections, as will be discussed in more detail in the following section.

Method's Steps and working Principles

FIGS. 9A and 9B show parts of embodiment 22 cut in half by a vertical cross section of the first kind (defined above). FIG. 9A shows beads 23 and 24 in enlarged view. The analysis of forces, torques, and working principles described in detail herein for gooseneck 22 also principally apply for embodiments 26, 30, 34, 38, 46, 50, and 52.

### First Step: One-Directional Design

Forces F in FIG. 9A are the forces of static friction that hold beads together and preserve the given configurations of gooseneck 22. Forces F are shown on the upper and lower surfaces of contact of contiguous beads 23 and 24. Frictional forces are spread on the surfaces, their direction opposing the bead-sliding tendency. Each of the two vectors F in FIG. 9A represents the sum or resultant of the frictional forces on the upper or lower contacting surfaces of the contiguous beads. The origin of each resultant force F is located in the middle or center of the contacting surfaces. The direction of resultant force F is opposite to the bead's sliding tendency. In response to various load weights, forces of static friction take various values up to a maximum (reached just before the bead surface starts sliding). Lever arm L_{F} is the lever arm of the couple of frictional forces F. Lever arm L_{F} is the shortest (perpendicular) distance between the two forces F. Total weight W is the sum of the weight of the load object (or transported fluid) and the weight of the gooseneck. Weight lever arm L_{W} is the lever arm of weight W.

With the arm in a steady equilibrium position, frictional forces produce as much frictional torque \vec{T}_{F}=\vec{F}×\vec{L}_{F} (clockwise) as needed to counterbalance weight torque \vec{T}_{W}=\vec{W}×\vec{L}_{W} (counterclockwise) of the weights of the load and the gooseneck (arrows for torques \vec{T}_{F} and \vec{T}_{W} are not shown in FIG. 9A). In calculations, the balancing torques must be referenced to a common origin. In this case the center of lever arm L_{F} is the center of both frictional and weight torques. Weight lever arm L_{W} is the distance from the center of frictional lever arm L_{F} to the center of gravity of total weight W. After the hands of the user give the gooseneck a certain configuration (place the load in a certain position), the gooseneck must be able to preserve the configuration. The vector sum of all torques in static equilibrium equals zero:

\vec{T}_{F}+\vec{T}_{W}=0(torque-balancing equation)

In any stable gooseneck configuration, the weight torque is balanced by the frictional torque. Otherwise, the beads will slide, the gooseneck will sag, and the load will hang down. The forces act along the cross-sectional plane, while the torques are perpendicular to it, as shown in FIGS. 9A and 9B. Already knowing the directions of forces and torques, the formulas can be simplified by replacing vector quantities with their magnitudes. The absolute value of a vector is equal to its magnitude, for example |\vec{F}|=F.

The torque balancing equation can be written as \vec{T}_{F}=−\vec{T}_{W}. After taking the absolute values of both sides |\vec{T}_{F}|=|−\vec{T}_{W}|, substituting forces and lever arms \vec{F}×\vec{L}_{F}=\vec{W}×\vec{L}_{W}, and substituting the cross products

F L_{F} sin 90°=W L_{W} sin 90°, the torque balancing equation that relates total weight W with frictional forces F and lever arms L_{W} and L_{F} can be written in its simplest form:

FL_{F}=WL_{W}(torque-balancing equation)

Making use of the known directions of the vectors shown in FIGS. 9A and 9B and of the non-shown related vectors, all formulas from this point on are written using vector magnitudes. As stated above, the total weight is the sum of the load weight and gooseneck weight or W=W_{L}+W_{G}. Weight-bearing is defined as the load weight W_{L} that can be handled by a gooseneck with a length of one unit. From the above definition of the total weight, the weight-bearing can be expressed as the difference of the gooseneck weight from the total weight: W_{L}=W−W_{G} (arrows of W_{L} and W_{G} are not shown in FIG. 9A). Following the above equation, one can maximize weight-bearing W_{L} by making design changes that increase weight W, or decrease weight W_{G}, or, even better, by making changes that increase W while decreasing W_{G}. Let's consider first the increase of weight W. The reader can notice from the torque balancing equation that weight W is equal to W=F L_{F}/L_{W}, or W=T_{F}/L_{W}.

Weight W can be increased by either maximizing frictional force torque T_{F}=F L_{F} or minimizing weight lever arm L_{W}, or by influencing both the torque and the lever arm. Minimizing L_{W} leads to a shorter gooseneck, which is usually unacceptable as the length of the gooseneck is determined by the needs of the application. Maximizing frictional torque T_{F}=F L_{F} is done by increasing either frictional forces F or lever arm L_{F}, or by increasing both the forces and the lever arm. There are known attempts made by the prior art to increase frictional forces F by introducing rough textures of contacting surfaces, by using alternating beads of different materials, or by employing tensioning cables that press beads tightly together to increase the friction.

On the other hand, as the consequence of the overall enlargements in the thickness of the goosenecks of the prior art, lever arms L_{F} are also increased. However, the prior art's thicker arms of larger diameters have made the arms bulky, wasted material, and increased the arms' weight. Designs of the prior art have been made as if the arms were operating in a circularly symmetric force field, which is not the case—the downward force field of weight is one-directional. The increases in arm weight W_{G} resulting from the size increases have negatively influenced weight-bearing W_{L}=W−W_{G}. The negative influence of W_{G} on the weight-bearing is also shown in the complete equation which explicitly includes all other factors influencing the weight-bearing. After substituting the value of W from the torque balancing equation W=F L_{F}/L_{W}, the detailed weight-bearing equation

W_{L}=FL_{F}/L_{W}−W_{G}(weight-bearing equation)

shows the variables that determine the weight-bearing. By examining influential factors in the equation one can optimize the arm design, improve weight bearing and reduce the arm's footprint. The above equation also proves the negative effect in weight-bearing of the unduly increases of W_{G} by the prior art.

In contrast with the prior art, the present invention takes a direct approach based on the torque analyses and weight-bearing equations shown in the paragraphs above. The present invention matches the one-directional symmetry of the vertically oriented weight field with the one-directional symmetry of the novel arm designs. Modifying the new designs accordingly to the weight field where arms operate, the present invention considers all the influential factors on the weight-bearing of the arms. Besides preserving those experiences of the prior art that are supported by the weight-bearing equation, such as the various methods of increasing frictional forces F, the present invention focuses on the direct increase of lever arm L_{F}, which effectively improves the weight-bearing W_{L}. In the first step, the new method of the present invention moves away from the circular designs of the prior art and makes design changes (see embodiments 22, 26, 30, 34, 38, 50, and 52) that increase lever arm L_{F} without increasing the overall gooseneck diameter. The first step improves the weight-bearing of the arms in a direct and effective way.

### Second Step: Combination

In the second step, the new method combines the novel gooseneck with a circular gooseneck. The second step preserves the bendability of the arms in the vertical direction, based on the following torque analysis. FIG. 9B shows weights and frictional forces for two remote sets of contiguous beads of embodiment 22. Frictional torque between two contiguous beads balances the torque created by the load weight and the weight of the gooseneck part that extends from the midpoint between the two beads to the load (left side in the figures). For example, frictional torque T_{W1} of the first set of beads balances the torque of load weight W_{L} and weight W_{G1} of the gooseneck length extending from the first set of beads to the load. The weight torque acting on the second set of beads is smaller than the weight torque on the first set: T_{W2}<T_{W1}, or in expanded form, W₂ L_{W2}<W₁ L_{W1}, for two reasons. First, lever arm L_{W2} is shorter than lever arm L_{W1}, as the second set of beads is closer to the load. Second, weight W₂=W_{L}+W_{G2} is smaller than weight W₁=W_{L}+W_{G1}, as the load weight is the same constant W_{L} while the length of the gooseneck from the second set of beads to the load is shorter than the length from the first set of beads to the load, making weights W_{G2}<W_{G1}, and W₂<W₁.

It is the nature of static frictional forces to gradually increase their values up as the maximum limit is reached just before the beads start sliding. Frictional torques follow and respond to various weight torques counterbalancing them and preserving the given gooseneck configuration, for as long as the weight-bearing limit is not surpassed. Combining inequality T_{W2}<T_{W1} (see above) with torque balancing equation T_{F}=T_{W} (valid for any location of the beads on the arm) results in the torque-decreasing inequality:

T_{F2}<T_{F1}(torque-decreasing inequality)

The frictional torque for the second set of beads is smaller than the frictional torque for the first set of beads. Expressed through forces and lever arms, the torque-decreasing inequality takes the form:

F₂L_{F2}<F₁L_{F1}

The needed frictional torques are smaller for the closer-to-the-load beads, permitting design changes that can make F₂<F₁, or L_{F2}<L_{F1}, or that can make both F₂<F₁ and L_{F2}<L_{F1}.

Specifically, the conclusion that frictional torques become smaller towards the load proves the validity of the second step of the new design method of the present invention. The linear combination of a novel (taller in cross section) gooseneck with a circular (smaller in cross section) gooseneck is suggested and justified by the torque-decreasing inequality.

Combination arm 54 of novel gooseneck 38 with circular gooseneck 46 is shown in the generic view of FIG. 10. A shorter length of a circular gooseneck is added between the load and the longer length of the novel gooseneck. The proximal end of the novel gooseneck serves as a close-up support point for the circular gooseneck. In FIG. 10, cross sections 55 and 56 are perpendicular to the goosenecks' longitudinal line. Notice the elongated cross section 55 and circular cross section 56. The vertical size of a cross section is effectively equivalent to the lever arm of the frictional forces. Circular gooseneck segment 46 has smaller, circular cross section 56 (smaller lever arm) than novel segment 38, which has a larger, vertically elongated cross section 55 (larger lever arm). The linear combination of the two types of goosenecks improves the arm's vertical bendability. Thus, the conclusion about the frictional torque values drawn from the analysis of torques along the arm length suggests the combination of a circular gooseneck and a novel gooseneck (the second step of the new method).

Also, the torque-decreasing inequality supports the decrease in the size of beads either gradually from bead to bead from the distal support side toward the proximal load side, or abruptly, by reducing the size of one or more segmental lengths of the gooseneck close to the load side. FIG. 11 shows a cylinder and sleeve type of gooseneck as an example of the abrupt reduction in the size of beads at one point on the arm. Segment 58 is reduced in size compared to segment 57. Compare the reduced-in-size gooseneck of FIG. 11 with the constant-size embodiment 30 of page 3 of the drawings. Bearing forces of embodiment 30 (analogous to the frictional forces in the example above) result from the clamping mechanical engagements between beads rather than friction alone. The lever arm of the mechanical engagement forces is reduced as a result of the overall reduction in size from segment 57 to segment 58. The torque-decreasing inequality explains the reduction in size along the arm, which can be either gradual from bead to bead (not shown) or in groups of several beads (shown in FIG. 11).

Both steps of the method and its working principles apply equally well for arms that employ tensioning cords. The only difference is that through the tensioning cord, the actuator, and handle, the user can control frictional forces between beads. The frictional forces become larger when the cord is more tensioned, and smaller when the cord is less tensioned. Frictional forces can be changed either discretely between two values (or even several values in steps), or gradually, in a continuous range of values from the smallest to the largest. The way frictional forces are controlled by the tensioning cord is determined by the type of actuator used.

### INDUSTRIAL APPLICABILITY

A central part of apparatus applications exemplified in FIGS. 12, 13, and 14 is the combination of a novel gooseneck with a circular one. The novel gooseneck increases the weight-bearing of the apparatus, while the circular gooseneck offers better position control in the vertical direction. As a result, the combination of the two pieces into one flexible arm gives the apparatus improved control and increased weight-bearing for load objects or streams of transmitted fluids. Manipulated objects are mounted at the proximal ends of the novel arms shown on the left sides of FIGS. 12, 13, and 14, with their distal ends either fixed or otherwise connected to various supports on the right side. In alternative embodiments, a tensioning cable may run through the hollow passages of flexible arms (see pages 2 and 3 of the drawings) to tighten the beads and increase friction on the surfaces of contact as the cable is tensioned by a handle (not shown). In FIG. 12, lighting device 60 joins the proximal end of novel gooseneck 54. Gooseneck 54 is made by fixedly connecting novel gooseneck 38 with circular gooseneck 46. The distal end of gooseneck 54 is rigidly connected to floor stand 62. Stem 64 of the floor stand has a hollow channel that allows electric wires to run through it. Line wires of an electric cord (not shown) enter base 66 of the floor stand, run through stem 64 and through an electric power control switch (not shown). Wires run further through the longitudinal internal channel of gooseneck sections 38 and 46, and feed electricity to lighting device 60. The double-headed arc and the double-headed arrows show the versatility of position and direction control of lighting device 60 in three-dimensions.

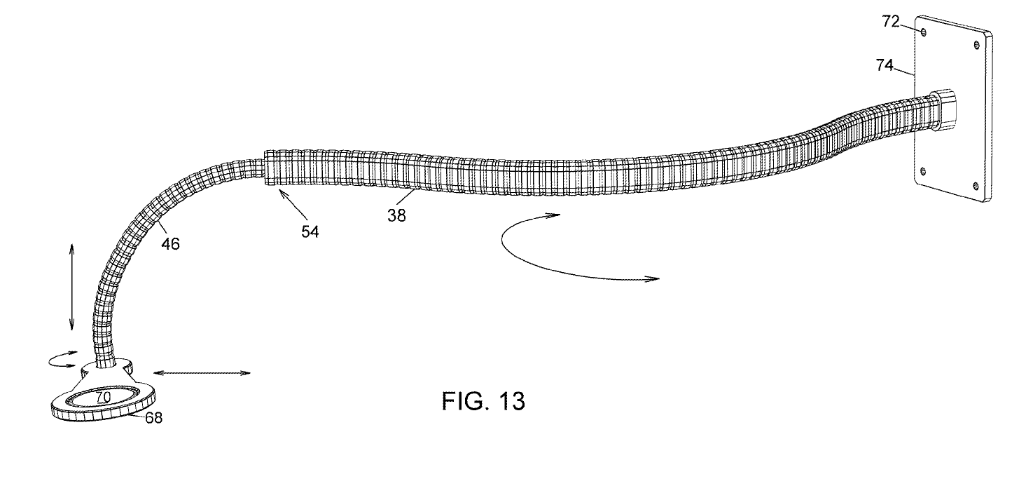

FIG. 13 provides an example of how novel arms can be used to manipulate measuring instruments, working tools, or observing devices. Lens holder 68 of optical lens 70 is pivotally connected at the proximal end of novel arm 54. Arm 54 is a linear combination of a shorter segment of circular gooseneck 46 with a longer segment of novel gooseneck 38. Flexible arm 54 and the pivotal connection of lens holder 68 give the user easy and complete position and direction control of lens 70. The connection is made by screw-locking or other means commonly used for locking and unlocking of tools and instruments; the above locking means are well known to those of ordinary skill in the art. The distal end of flexible arm 54 is rigidly connected on the surface of a wall or another object, equipment, or machinery using plate 74 (fixed firmly through screw holes 72). Double-headed arrows and double-headed arcs in FIG. 13 indicate the three-dimensional adjustability of position and direction for lens holder 68. Lens 70 is used here as an example of a tool or instrument mounted on a novel flexible arm. Other tools or measuring instruments can be joined fixedly or rotatably to the proximal end of novel arm 54. For example, embodiment 26 of arm 54 can also be used in a similar arrangement with FIG. 13 to support suction pods in beating heart surgery. Once suction pods are applied to the heart surface, tightening tensioning cable 29 (FIGS. 2A, and 2B) fixes the arm in place. With its improved weight-bearing, novel arm 54 permits a smaller profile assembly while further insuring adequate rigidity. The narrower profile improves the ability of the surgeon to use the device without unduly restricting accessibility to the surgical site. Medical applications of novel arm 54 are significantly advantageous to the existing articulating arms of the prior art. In some cases, gooseneck 38 may suffice (no need for combination 54).

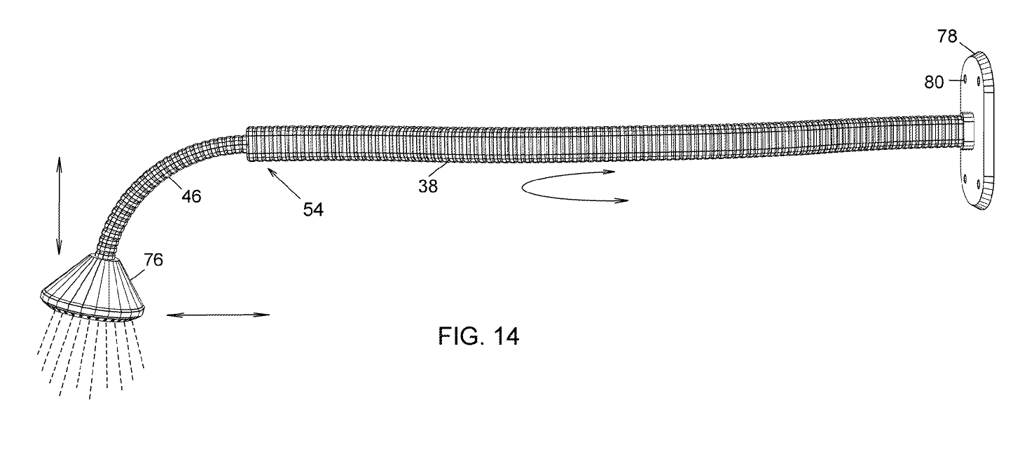

FIG. 14 shows a flexible shower arm assembly. Showerhead 76 is connected and manipulated at the proximal end of novel arm 54. The distal end of novel arm 54 is connected with the water supply line, and is rigidly fixed to the shower wall (not shown) using screw holes 78 of connection plate 80. Arm 54, incorporating circular gooseneck 46 and novel gooseneck 38, enclose a channel that can be used to transmit fluids in various applications. In the example of FIG. 14, novel arm 54 carries the supply water to showerhead 76. Novel arm 54 allows the user to freely adjust the position of showerhead 76 in three dimensions by configuring the shape of the shower arm attached between the water source, such as a shower pipe (not shown), and the water dispenser, such as showerhead 76. Novel gooseneck 38 carries the weight of the transported water and the weight of the showerhead. It is easy bendable in the horizontal direction by the hand(s) of the user. Circular gooseneck 46, easy bendable in three directions, is positioned closer to and connected with a water dispenser, such as showerhead 76. It is sealingly attached to the shower pipe by a pipe connector nut, and is sealingly and pivotally attached to showerhead 76. The types of the afore-mentioned connections and other similar types of connections are well known to those of ordinary skill in the art.

The combination of circular gooseneck 46 and novel gooseneck 38 increases the weight-bearing of flexible arm 54 and allows showerhead 76 to be positioned further away from the sidewall than through the flexible arms of the prior art. Arm 54 provides improved water-spray control to the shower-user. The particular position of showerhead 76 and the direction of the shower spray can be modified by reconfiguring the shape of shower arm 54. Arm 54 maintains the desired position until modified by the user. The double-headed arc arrow and the two double-headed straight arrows in FIG. 14 show the versatility of position and direction control of the showerhead in three dimensions.

Other apparatus may employ only gooseneck 38, rather than combination 54, in applications that require only moderate vertical adjustment of the load.

Operation of exemplary apparatus is straightforward. The user can push or pull the load slightly with one hand in any position or direction. Only in rare cases of relatively large position adjustments, the user may have to hold the load with one hand while bending the flexible arm with the other. For arms employing a tensioning cable, a handle is manipulated to tighten the cable at a fixed configuration, or release the cable to reconfigure the arm.

### SPECIAL TECHNICAL FEATURES AND ADVANTAGES

Special technical features of flexible arms of this invention are representatively revealed by embodiments 22, 26, 30, 34, 38, 50, and 52. The vertically elongated cross-section is a critical technical feature. While there are variations that create different embodiments, all of them have in common the special technical feature of vertically elongated cross-section. All embodiments involve this technical feature as a general inventive concept. The vertical elongation distinguishes and makes contrast with the circularity of the prior art.

The present invention is based on the analysis of structures and workings of flexible arms of all known types. The analysis of forces and torques between contiguous beads revealed the mismatch between the cross-sectional circularity of the prior art arms and one-directionality of the weight forces in the presence of which the arms operate. This invention points out the flaw of the circular-unidirectional mismatch of the prior art, and corrects it by introducing new goosenecks that match the vertical directionality of the weight field. By correcting the problem, the present invention brings significant improvement in both weight-bearing and footprints of goosenecks in the entire range of applications from the medical curvilinear articulating arms to the shower flexible arms. The complete analysis of gooseneck torques and loads characterizes this invention and is its other distinct feature. After a long and deep search of the prior art, there was not found any other patent or publication showing any similar force analysis.

Other structural features that are clearly shown in the drawings and disclosed in the description enhance the performance of various embodiments and create versatility of applications. Structural features provide functionality and operational convenience that are critical for industrial applicability. Special technical features define contributions of this invention over the prior art.

Novel goosenecks of this invention can satisfy an increased variety of customer needs for holding and manipulating various devices, tools, or instruments and for transmitting various fluids. The narrower-elongated profile design of novel goosenecks increases weight-bearing without unduly restricting the user's accessibility at the load site. The novel gooseneck is small in cross-sectional size, light in its weight, and has increased load-weight-bearing. The novel gooseneck can hold the load relatively far away from the supporting point while permitting load displacement in any direction. The narrow profile and small footprint of the new arms offer the user easy accessibility to the working spot. These features are critical in the medical area, where the new arms will free up working space and allow the surgeon to use the device at restricted surgical spots.

A short piece of a circular gooseneck is added between the load and the novel gooseneck. The proximal end of the novel gooseneck serves as a close-up support point for the circular gooseneck. The linear combination of the novel and circular goosenecks optimizes the weight-bearing and the vertical bendability of the arm.

Any of novel gooseneck embodiments 22, 26, 30, 34, 38, 50, and 52 can be used in the three described application apparatus, either alone or in combination with circular embodiments 46. In this disclosure, application apparatus are given by examples, but many other similar applications are possible and obvious to those skilled in the art. Choices of certain embodiments will depend on the specific requirements of the application and the user's preferences. Many other ramifications and variations are possible within the teachings of these examples. Therefore, specific structural and functional details disclosed herein are not to be interpreted as limiting, but merely as a representative basis for teaching one skilled in the art to variously employ the present invention. Thus, the scope of the embodiments should be determined by the appended claims and their legal equivalents, rather than by the examples given.

What is clamed is:

1. Flexible arms comprising structural features representatively revealed by embodiments 22, 26, 30, 34, 38, 50, and 52 of this disclosure,
said flexible arms having a longitudinal axis and cross sections that are perpendicular to said longitudinal axis,
wherein said flexible arms are characterized by their said cross sections being vertically elongated planes with longer vertical than horizontal sizes.

2. Flexible arms of claim 1, further including a circular flexible arm representatively revealed by embodiment 46,
wherein said flexible arms of claim 1 and said circular flexible arm of embodiment 46 have one proximal end and one distal end,
wherein at the proximal end of one of said flexible arms of claim 1 is joined linearly the distal end of said circular flexible arm of embodiment 46,
wherein, after the joint, the two linearly combined flexible arms become a single and longer flexible arm.

3. The flexible arms of claim 2, further including a lighting device and a floor stand,
wherein any of said flexible arms have one proximal end and one distal end,
wherein said lighting device is attached at said one proximal end of one of said flexible arms,
wherein said one distal end of one of said flexible arms is attached to said floor stand, and
further including an electric power cord connected to a receptacle and controlled by an electric switch, wherein said electric power cord extends inside a channel running through said floor stand and said one of flexible arms and connects to said lighting device.

4. The flexible arms of claim 2, further including an optical lens and a support plate,
wherein any of said flexible arms have one proximal end and one distal end,
wherein said optical lens is attached at said one proximal end of one of said flexible arms, and
wherein said one distal end of one of said flexible arms is attached to said support plate.

5. The flexible arms of claim 2, further including a showerhead and a connection plate,
wherein any of said flexible arms have one proximal end and one distal end,
wherein said showerhead is sealingly attached at said one proximal end of one of said flexible arms,
wherein said one distal end of one of said flexible arms is attached to said connection plate,
wherein said connection plate is sealingly joined with a shower pipe, and
wherein water is transported along an internal passage through one of said flexible arms to said showerhead and dispensed to a shower user.

6. A method of flexible arm design comprising,
providing flexible arms with structures representatively revealed by embodiments 22, 26, 30, 34, 38, 50, and 52 of this disclosure,
said flexible arms having a longitudinal axis and cross sections that are perpendicular to said longitudinal axis, and
wherein said flexible arms are characterized by their said cross sections being vertically elongated planes with longer vertical than horizontal sizes.

7. The method of claim 6,
further providing a circular flexible arm with features representatively revealed by embodiment 46 of this disclosure,
wherein said flexible arms of claim 6 and said circular flexible arm of embodiment 46 have one proximal end and one distal end,
wherein at the proximal end of one of said flexible arms of claim 6 is joined linearly the distal end of said circular flexible arm of embodiment 46,
wherein, after the joint, the two linearly combined flexible arms become a single and longer flexible arm.

8. The method of claim 7,
further providing a lighting device and a floor stand,
wherein said lighting device is attached at said one proximal end of one of said flexible arms,
wherein said one distal end of one of said flexible arms is attached to said floor stand,
further providing an electric power cord connected to a receptacle and controlled by an electric switch,
wherein said electric power cord extends inside a channel running through said floor stand and said one of flexible arms and connects to said lighting device.

9. The method of claim 7,
further providing an optical lens and a support plate,
wherein said optical lens is attached at said one proximal end of one of said flexible arms, and
wherein said one distal end of one of said flexible arms is attached to said support plate.

10. The method of claim 7,
further providing a showerhead and a connection plate,
wherein said showerhead is sealingly attached at said one proximal end of one of said flexible arms,
wherein said one distal end of one of said flexible arms is attached to said connection plate,
wherein said connection plate is sealingly joined with a shower pipe, and
wherein water is transported along an internal passage through one of said flexible arms to said showerhead and dispensed to a shower user.
